(19) United States
(12) Patent Application Publication
(10) Pub. No.: US 2006/0097013 A1
(43) Pub. Date: May 11, 2006

(54) Dispenser

(76) Inventor: Adrian Neil Bargh, Hertfordshire (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/548,077

(22) PCT Filed: Apr. 15, 2004
(86) PCT No.: PCT/EP04/03964

§ 371 Date: Oct. 3, 2005

(30) Foreign Application Priority Data
Apr. 28, 2003 (EP) 03232685.7

(51) Int. Cl. B65D 88/54; B67D 3/00

(52) U.S. Cl. 222/319; 222/485

(57) ABSTRACT

A dispensing array is disclosed which comprises a number of dispensers (10). Each of the dispensers consists of a syringe (11) and two two-port rotary valves (15, 16). The inlet two-port rotary valve (15) allows fluid to be drawn into the syringe from a reservoir and the outlet two-port rotary valve (16) allows fluid to be dispensed from a dispensing tip.

The present invention relates to dispensers for dispensing low volumes of fluids and, more particularly for dispensing small volumes of suspensions.

A conventional syringe pump for dispensing small volumes of fluid is mounted vertically with a three port rotary valve at the top of a syringe chamber and a plunger at the bottom being drawn downwards to draw liquid into the syringe chamber from a reservoir. The aim of mounting a syringe vertically is that it should help to remove air from the syringe as air bubbles rise naturally towards the valve. The valve can be switched to connect the syringe chamber to either an input port or an output port. An inherent problem with the configuration of a three port valve is that there is a dead volume between the syringe chamber and the valve itself. This dead volume results in trapped air being unable to exit the syringe. When the plunger is at the top of its stroke, the air is pushed into the dead volume. However, when the syringe is refilled, because the refilling occurs through the same inlet, the trapped air is pushed back into the syringe ahead of the inflowing fluid. Thus, the configuration of such syringe pump dispensers results in air bubbles becoming trapped and only being persuaded to leave the syringe chamber by manually tapping the syringe. Air bubbles in the syringe can cause the dispensing performance to be reduced to a level at which dispensing reliability is not acceptable, as a result of the fact that the air is much more easily compressed than the liquid to be dispensed, in turn resulting in unacceptable volume variation.

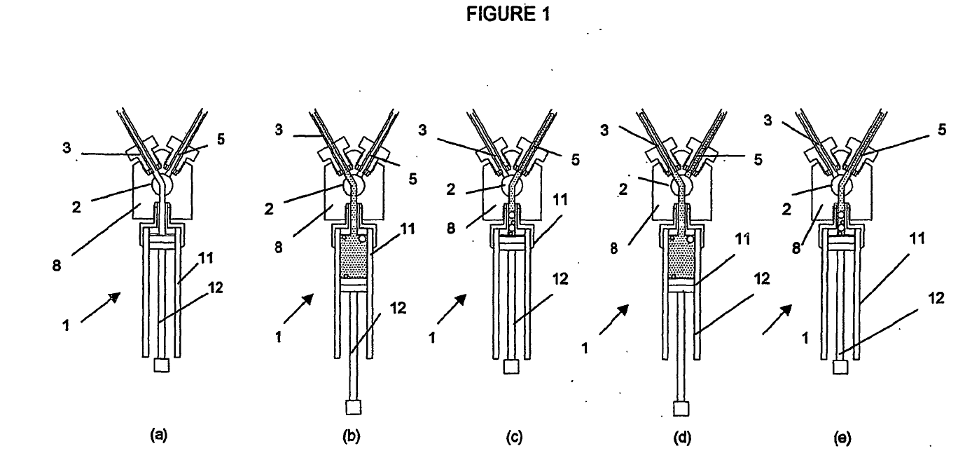

A typical syringe dispenser having a three port valve configuration is shown in FIG. 1a-e. These figures show a conventional syringe pump 1 being filled and emptied. FIG. 1a shows the syringe pump when it is not in use and the syringe 11 is empty. FIG. 1b shows the syringe being filled through the inlet port 3 via the three port valve 2, a number of air bubbles 13 are shown trapped in the syringe 11. FIG. 1c shows the syringe dispensing through the outlet port 5 via the three port valve 2. It shows that once the syringe plunger 12 is at the top of its stroke and the syringe 11 is empty, the air bubbles 13 have moved out into a dead volume 8 that lies between the top of the syringe 11 and the three port valve 2. Because this dead volume 8 it part of the fluid passageway from the inlet port 3 into the syringe 11 then, as shown in FIG. 1d, when the syringe is refilled through the inlet port the air bubbles 13 are forced back into the syringe 11 ahead of the incoming fluid 14.

Furthermore, it has been observed that, as a result of the vertical configuration of the syringe, if a suspension is to be dispensed there can be a considerable difference in concentration between the first volume dispensed and the last within a single syringe stoke as a result of the settling of the suspension towards the position of the syringe plunger.

According to the present invention there is therefore provided a dispensing assembly including a dispenser comprising:

a dispensing tip;

a syringe having a tube and a movable plunger,

two two-port rotary valves providing an inlet valve and an outlet valve, at the end of the tube opposite the plunger,

the inlet two-port rotary valve being connected in use to a reservoir of fluid to allow fluid to be drawn into the syringe from the reservoir, and the outlet two-port rotary valve being connected to the dispensing tip to allow fluid to be dispensed therefrom.

The syringe may be arranged to be disposed substantially horizontally resulting in the two two-port rotary valves being positioned one above the other and therefore the inlet valve is positioned below the outlet valve in use.

The syringe plunger may be removable and the end portion of the syringe with a larger cross sectional area. The syringe tube may be a glass tube.

A dispensing array may be formed comprising a plurality of dispensers wherein the dispensing tips and syringe plungers are configured to form substantially parallel arrays.

Such a dispensing array may further comprise an actuator configured to actuate the syringe plungers simultaneously.

The dispensing array may be cleaned and purged of air by the following steps:

lowering the array of dispensing tips into the gutter,

depressing the plunger to force the liquid out through the upper two-port rotary valve, forcing any trapped air bubbles into the upper two-port rotary valve and forcing the fluid through the tips such that it flows up around the tip end.

Preferably, the drawing in and dispensing of fluid is repeated, the first fluid being PBS and the second being a water and alcohol mix.

Furthermore according to the present invention there is provided a method of cleaning syringes in a dispensing array comprising the steps of:

drawing fluid through the lower two port valve until the syringe is full,

continuing to draw fluid forcing the plunger to be disconnected from the syringe tube and allowing fluid to flow out of the end of the tube and into the overflow zone.

An example of a dispenser according to the present invention will now be further described with reference to the accompanying drawings in which:

FIGS. 1a-e shows the configuration and operation of a conventional three port valve syringe pump.

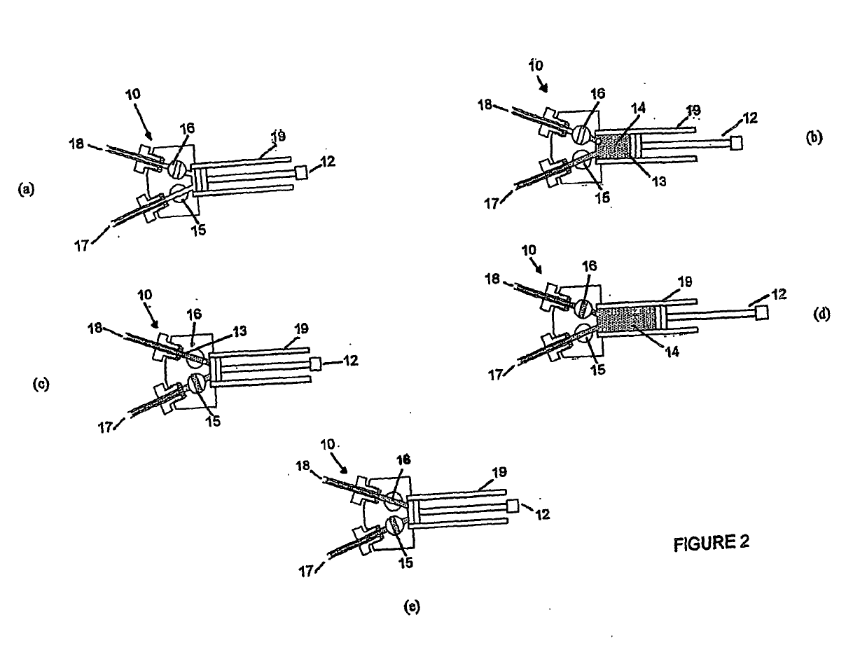

FIGS. 2a-e shows the sequence of operation and configuration of valves in a dispenser according to the present invention.

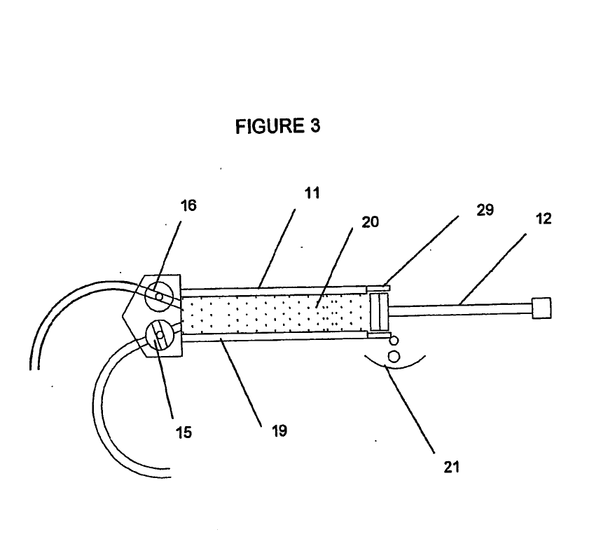

FIG. 3 shows the configuration of the syringe allowing for the method of cleaning according to the present invention.

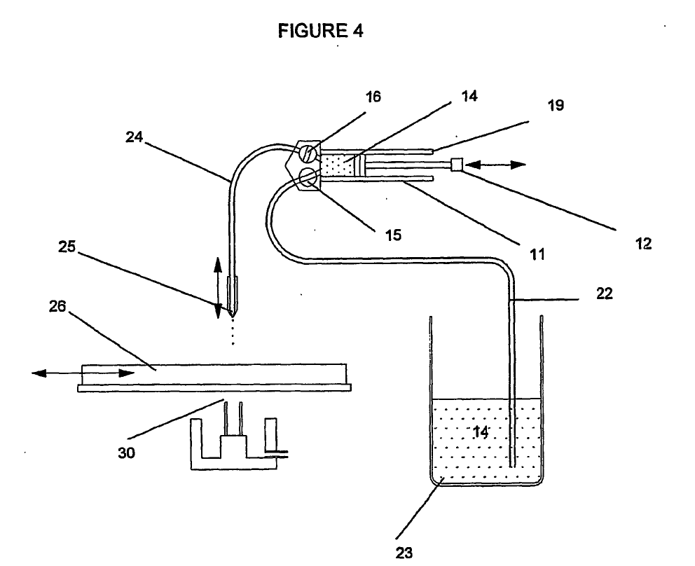

FIG. 4 shows a dispenser according to the present invention.

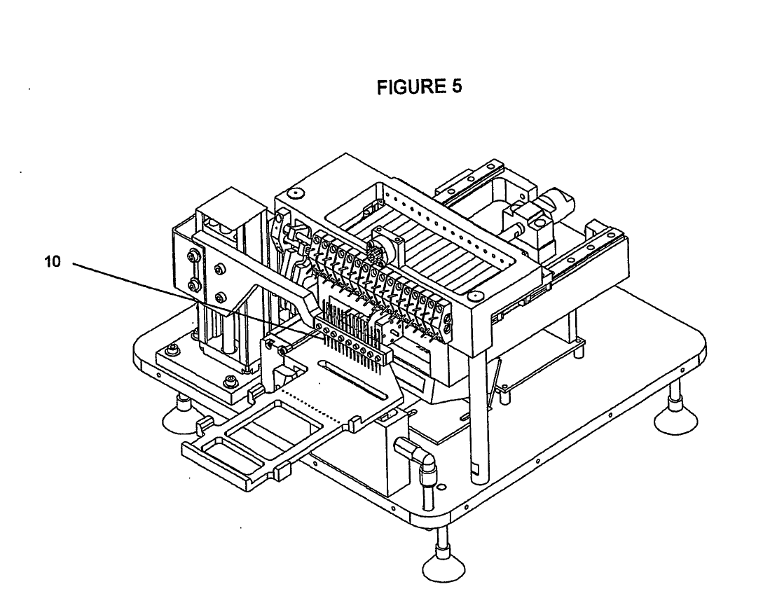

FIG. 5 shows a dispensing array according to the present invention.

FIGS. 2a-e show the configuration and operation of an example of a dispenser 10 according to the present invention. The dispenser 10 comprises a syringe 11 with two two-port rotary valves 15 and 16. In use, the syringe 11 is disposed horizontally resulting in the inlet port 17 sloping upwards towards the syringe 11 and the outlet port 18 sloping upwards away from the syringe 11. The syringe 11 consists of a glass barrel 19 and a syringe plunger 12. FIG. 2a shows the dispenser 10 when it is not in use. The syringe 11 is devoid of fluid 14. Prior to and following use the dispenser 10 of the present invention is washed through. A two stage washing process is used. Firstly, as shown in FIG. 2b, a fluid such as Phosphate Buffered Saline (PBS) is drawn in through the inlet port 17, through the lower of the two-port rotary valves 15 and into the syringe 11. It will be evident from FIG. 2b that air bubbles within the fluid may be trapped within the syringe. Valve 15 is then closed and valve 16 opened in order to allow the syringe 11 to be used for dispensing via the upper, outlet, two port valve 16 and the outlet 18. The air bubbles 13 therefore move into the outlet two port valve and leave the syringe 11. These two stages may then be repeated with a water/alcohol mix in order to sterilise the liquid path. FIG. 2d shows the syringe filled with the fluid 14 to be dispensed. It is clear that the air bubbles 13 do not re-enter the syringe 11 and therefore do not introduce the inconsistencies in volume dispensed that result from air bubbles, which are compressible, being trapped within the syringe 11. FIG. 2e shows the syringe at the end of the priming cycle.

It is apparent from FIG. 2 that, in comparison with a conventional three port valve shown in FIG. 1, the two two-port valves are separated vertically as a result of the horizontal configuration of the syringe. The horizontal configuration of the syringe 11 also reduces the effect of settling if a suspension is to be dispensed because the height of the column of fluid is shorter and therefore the variation in the concentration of the suspension between the first and last samples dispensed within one stroke of the plunger syringe is reduced by using a dispenser of this type.

FIG. 3 shows detail of the syringe 11. In particular, it shows a method of cleaning the syringe 11. The glass barrel 19 of the syringe 11 has an end portion 29 of thinner glass than the main part of the barrel which allows the syringe plunger 12 to be held securely whilst allowing a small amount of wash fluid 20 to flow past the syringe plunger and out of the end of the glass barrel 19 into an overflow 21. The overflow 21 collects the fluid flowing from the end portion 29 of the syringe 11. This allows the wash fluid 20 to cleanse the inner surface of the glass barrel 19 and the syringe plunger 12 of any crystals that may have formed thereon.

FIG. 4 shows further detail of the dispenser. The lower two port valve 15 leads, via liquid input tubing 22, to a liquid reservoir 23 containing the fluid to be dispensed 14. The upper two port valve 16 leads, via liquid output tubing 24, to a dispensing tip 25 from which fluid 14 is dispensed on to a conventional micro plate 26. When the syringe is washed with PBS or alcohol/water mix the dispensing tip 25 is repositioned such that the wash fluids are dispensed into a gutter 30 positioned below the micro plate 26. The micro plate 26 is capable of horizontal movement to allow fluid to be dispensed to different parts of the micro plate 26 and also to allow access to the gutter 30 which is positioned below the dispensing tip 25. When the dispenser 10 is washed the dispensing tip 25 can be lowered into the gutter 30. The gutter 30 has substantially parallel walls that conform closely to the outer surface of the dispensing tip 25. As the PBS or water/alcohol mixture is dispensed through the dispensing tip 25 the fluid is forced to flow up around the outer surface of the dispensing tip 25 thereby cleansing the tip 25.

A dispensing array can be formed from a plurality of dispensers 10 as shown in FIG. 5. The dispensing tips 25 of the dispensers are formed into a substantially parallel dispensing array. Furthermore, the syringes 11 are also formed into a substantially parallel array such that the plungers 12 of the dispensers can be actuated simultaneously by an actuator moving in a plane perpendicular to the plane of the array of plungers 12.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A dispensing assembly including a dispenser comprising:
a dispensing tip;
a syringe having a tube and a movable plunger engaging the tube at a first end, the syringe being disposed substantially horizontally while in use;
two two-port rotary valves providing an inlet valve and an outlet valve disposed at a second end of the tube opposite the plunger,
the inlet valve two-port rotary valve being positioned below the outlet valve while in use, and being connected while in use to a reservoir of fluid to allow fluid to be drawn into the syringe from the reservoir, and the outlet valve being connected to the dispensing tip to allow fluid to be dispensed therefrom.

13. A dispensing assembly according to claim 12, wherein the syringe plunger is removable.

14. A dispensing assembly according to claim 12, wherein an end portion of the syringe has a larger cross sectional area.

15. A dispensing assembly according to claim 12, wherein the syringe tube is a glass tube.

16. A dispensing array comprising a plurality of dispensers according to claim 12 wherein the dispensing tips and syringe plungers are configured to form substantially parallel arrays.

17. A dispensing array according to claim 12, further comprising an actuator configured to actuate the syringe plungers simultaneously.

18. A method of cleaning and purging air from an array of a plurality of syringe dispensers each of which has a tube with a two-port inlet valve and a two-port outlet valve at one end, a dispensing tip coupled to the outlet, and a movable plunger operative from an opposite end, a the method comprising steps of:
orienting the tube so that the tube is horizontal and the two-port inlet valve is below the two-port outlet valve;
drawing fluid from a reservoir through the lower inlet two-port valve into the tube;
lowering the array of dispensing tips into a gutter,
depressing the plunger to force the liquid out through the upper valve, forcing any trapped air bubbles into the upper two-port valve and forcing the fluid through the tip such that is flows up around the tip end.

19. A method according to claim 18, wherein the drawing in and dispensing of fluid is repeated with different fluids, a first fluid being PBS and a second being a water and alcohol mix.

20. A method of cleaning syringes in a dispensing array formed of a plurality of syringe dispensers each having a tube with a two-port inlet valve and a two-port outlet valve at one end and a dispensing tip coupled to the outlet; and a movable plunger, the method comprising the steps of:
orienting the syringe substantially horizontally and with the two-port outlet valve positioned above the two-port inlet valve;
drawing fluid from the reservoir through the lower two-port inlet valve until the syringe is full,
continuing to draw fluid forcing the plunger to be disconnected from the syringe tube and allowing fluid to flow out of the end of th tube and into an overflow zone.
